(19) United States
(12) Patent Application Publication
(10) Pub. No.: US 2019/0061834 A1
(43) Pub. Date: Feb. 28, 2019

(54) VEHICLE CHASSIS STRUCTURE AND METHOD OF ASSEMBLING USING STRUCTURAL ADHESIVE

(71) Applicant: GM Global Technology Operations LLC, Detroit, MI (US)

(72) Inventors: Balbir S. Sangha, Ajax (CA); Fred M. Marquardt, Commerce, MI (US); Len V. Peschansky, West Bloomfield, MI (US); Joseph M. Madafferi, South Lyon, MI (US)

(21) Appl. No.: 15/684,249

(22) Filed: Aug. 23, 2017

(51) Int. Cl. B62D 27/02; B62D 29/00; B62D 65/02; B29C 65/48; B29C 65/02; C09J 5/06

(52) U.S. Cl. CPC B62D 27/026; B62D 27/023; B62D 29/008; B29L 2031/30; B29C 65/48; B29C 65/02; C09J 5/06; B62D 65/02

(57) ABSTRACT

A vehicle chassis structure includes a clamshell assembly, a third member, and a structural adhesive. The clamshell assembly includes a first member having a first concave surface and a second member having a second concave surface. The third member includes a convex face opposed by the first and second concave surfaces. The structural adhesive is disposed between, and in contact with, the first concave surface and the convex face, and is disposed between, and in contact with, the second concave surface and the convex face.

### INTRODUCTION

The subject invention relates to a vehicle chassis structure, and more particularly, to vehicle chassis structures utilizing structural adhesives and a method of assembling.

Traditional vehicles chassis structures have various components that are made of a common material (e.g., steel, aluminum) and are interconnected via traditional methods such as welding and mechanical fasteners. Such methods of assembling and limited choices in material may not be conducive toward reducing manufacturing cost and vehicle weight. Further, such methods may limit design options that may impact overall vehicle performance and efficiencies.

### SUMMARY

A vehicle chassis structure according to one, non-limiting, embodiment of the present disclosure includes a clamshell assembly, a third member, and a structural adhesive. The clamshell assembly includes a first member having a first concave surface and a second member having a second concave surface. The third member has a convex face opposed to the first and second concave surfaces. The structural adhesive is disposed between, and in contact with, the first concave surface and the convex face. Moreover, the structural adhesive is disposed between, and in contact with, the second concave surface and the convex face.

Additionally to the foregoing embodiment, the convex face is circumferentially continuous.

In the alternative or additionally thereto, in the foregoing embodiment, the first and second concave surfaces extend circumferentially about the convex face.

In the alternative or additionally thereto, in the foregoing embodiment, the third member includes a center-point and the first and second concave surfaces are diametrically opposed to one-another with respect to the centerpoint.

In the alternative or additionally thereto, in the foregoing embodiment, the third member is an elongated member extending along a centerline that extends through the centerpoint.

In the alternative or additionally thereto, in the foregoing embodiment, the clamshell assembly and the third member are made of dissimilar materials.

In the alternative or additionally thereto, in the foregoing embodiment, the clamshell assembly is a node and the third member is one of a plurality of third members each attached to the node via the structural adhesive.

In the alternative or additionally thereto, in the foregoing embodiment, the vehicle chassis structure is an engine cradle.

In the alternative or additionally thereto, in the foregoing embodiment, the node is made of aluminum and the plurality of third members are made of steel.

In the alternative or additionally thereto, in the foregoing embodiment, the first member includes a base surface disposed substantially normal to the first concave surface, and the second member includes a flange segment adhered to the base surface via the structural adhesive.

In the alternative or additionally thereto, in the foregoing embodiment, the vehicle chassis structure includes a fourth member including a fourth convex face, wherein the clamshell assembly includes a fifth member carrying a fifth concave surface, and wherein the first member includes a base portion, a first abutment portion projecting outward from the base portion and that carries the first concave surface, and a second abutment portion projecting outward from the base portion and carrying a fourth concave surface, and wherein the fourth and fifth concave surfaces are adhered to the fourth convex face via the structural adhesive.

A method of assembling a vehicle chassis structure according to another, non-limiting, embodiment includes placing a structural adhesive upon at least one of a concave surface carried by the clamshell assembly and a convex face carried by the member. Once placed, the clamshell assembly is directed in a radially inward direction to compress the structural adhesive between the clamshell assembly and the convex face while minimizing adhesive wiping.

Additionally to the foregoing embodiment, the clamshell assembly includes diametrically opposed first and second members each including respective first and second concave surfaces of the concave surface.

In the alternative or additionally thereto, in the foregoing embodiment, directing the clamshell assembly in a radially inward direction includes joining the first concave surface to the convex face and joining the second concave surface to the convex face.

In the alternative or additionally thereto, in the foregoing embodiment, the convex face is circumferentially continuous.

In the alternative or additionally thereto, in the foregoing embodiment, the first and second concave surfaces surround the convex face.

In the alternative or additionally thereto, in the foregoing embodiment, the method includes applying heat to cure the structural adhesive.

The above features and advantages and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of a vehicle chassis structure as one, non-limiting, exemplary embodiment in accordance with the present disclosure;

FIG. 2 is an enlarged disassembled perspective, top, view of the vehicle chassis structure taken at circle 2 of FIG. 1;

FIG. 3 is an enlarged assembled, bottom view of the vehicle chassis structure;

FIG. 4 is a plan view of a clamshell assembly of the vehicle chassis structure;

FIG. 5 is a flow chart illustrating a method of assembling the vehicle chassis assembly;

FIG. 6 is a disassembled perspective view of a second embodiment of the vehicle chassis assembly; and

FIG. 7 is an assembled perspective view of the second embodiment of the vehicle chassis assembly.

### DETAILED DESCRIPTION

The following description is merely exemplary in nature and is not intended to limit the present disclosure, its application or uses. It should be understood that throughout the drawings, corresponding reference numerals indicate like or corresponding parts and features.

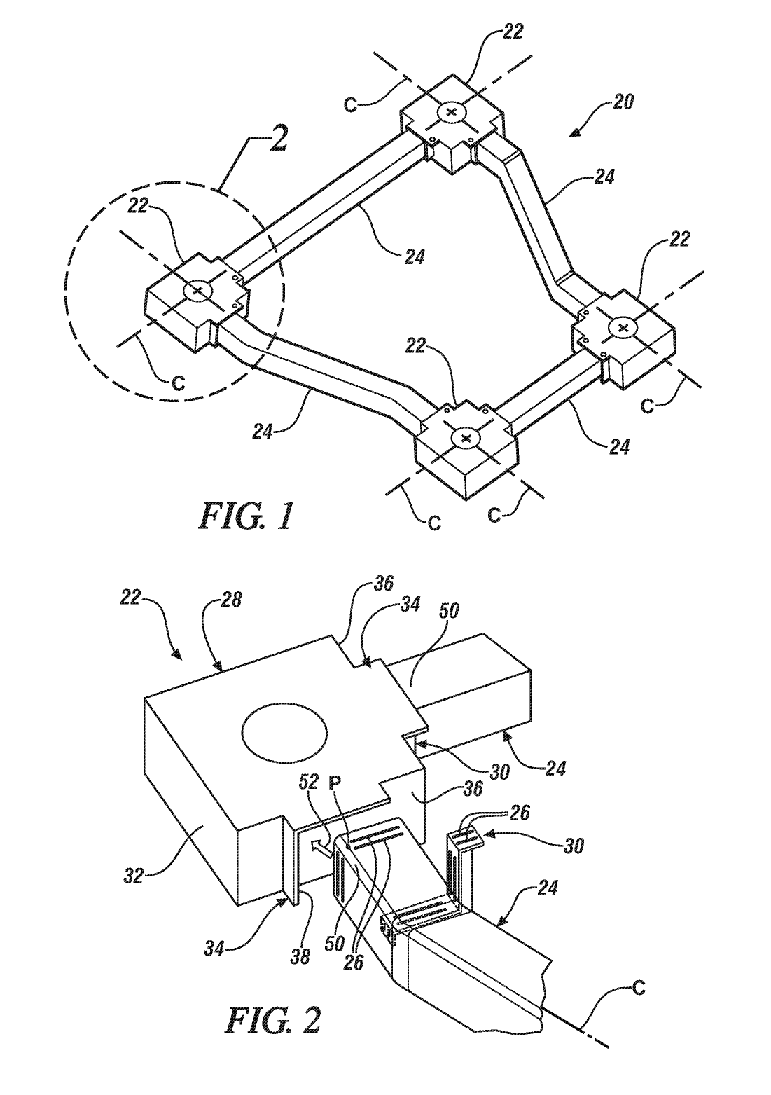

Referring to FIG. 1 and in accordance with an exemplary embodiment, a vehicle chassis structure 20 may include an article 22 and a member 24 adhered together by a structural adhesive 26 (see FIG. 2). In one, non-limiting, embodiment, the chassis structure 20 may be an engine cradle, and article 22 may be an interconnecting node, or clamshell assembly. The engine cradle 20 may include multiple members 24 (i.e., four illustrated) interconnected by multiple clamshell assemblies 22 (i.e., four illustrated). Each member 24 may be tubular, and/or may be elongated extending along respective centerlines C that may generally intersect one-another at the associated nodes 22. In other embodiments, the chassis structure 20 may be side rails, cross beams, and other structures having multiple components adhered together by the structural adhesive 26. One, non-limiting, example of the structural adhesive 26 may be an epoxy, which may be heat cured.

Referring to FIGS. 2 and 3, the clamshell assembly 22 may include a first member 28 and at least one second member 30 (i.e., two illustrated). The first member 28 may include a base portion 32 and at least one abutment portion 34 (i.e., two illustrated) that project outward from respective base surfaces 36 carried by the base portion 32. Each abutment portion 34 carries a concave surface 38 that may be substantially normal to the base surface 36. When the chassis structure 20 is assembled, a centerpoint P, orientated with respect to the abutment portion 34 may generally lie within the centerline C of the respective member 24. The concave surface 38 faces radially inward with respect to, and is substantially symmetrically aligned to, the centerpoint P.

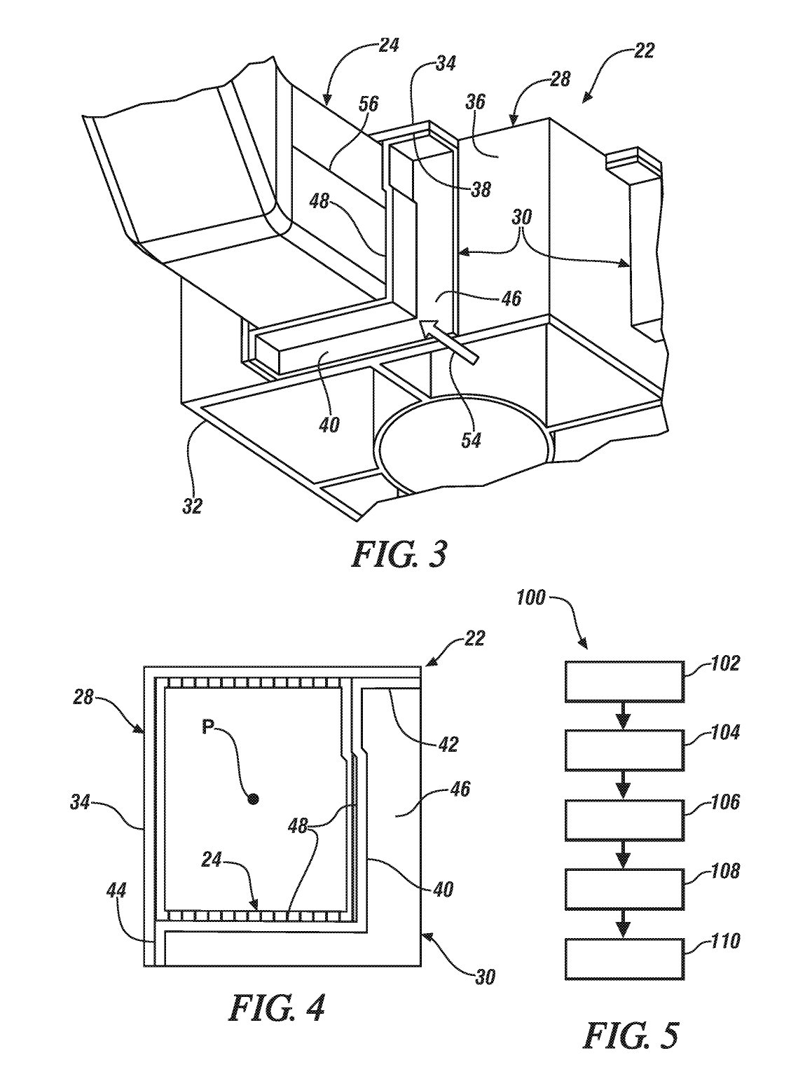

Referring to FIGS. 2, 3, and 4, prior to assembly, the second member 30 is separate from the first member 28. The second member 30 may include a mid-segment 40, opposite tab segments 42, 44, and a flange segment 46. The tab segments 42, 44 may project substantially radially outward from opposite end portions of the mid-segment 40 and with respect to centerpoint P (i.e., when assembled). The mid-segment 40 carries a concave surface 48 that faces radially inward with respect to, and is generally symmetrically aligned to, the centerpoint P when assembled. The flange segment 46 is generally elongated, longitudinally extending circumferentially with respect to centerline C (i.e., when assembled), and projecting radially outward from the mid-segment 40. In one embodiment, end portions of the flange segment 46 may be attached to the respective tab segments 42, 44.

The member 24, which may be a tubular member, carries a convex face 50 that faces radially outward with respect to centerline C. In one embodiment, the convex face 50 may be circumferentially continuous. Similarly, the concave surface 38 of the abutment portion 34 and the concave surface 48 of the mid-segment 40 may each span circumferentially by about 180 degrees. When assembled, the combined concave surface 38, 48 may be circumferentially continuous.

When the chassis structure 20 is fully assembled, a portion of the convex face 50 of the member 24 (e.g., tubular member) and the opposing concave surface 38 of the abutment portion 34 of the member 28, are adhered to one-another by the structural adhesive 26. Similarly, another portion of the convex face 50 of the member 24 and the opposing concave surface 48 of the mid segment 40 of the member 30, are adhered to one-another by the structural adhesive 26. Further, the flange segment 46 of the member 30 may be adhered to the base surface 36 of the base portion 32 of the member 28, and the tab segments 42, 44 may be adhered to opposite end portions of the concave surface 38 of the abutment portion 34 of the member 28.

The members 24, 28, 30 may be made of dissimilar materials. In one embodiment, the node or clamshell assembly 22 (i.e., both members 28, 30) may be made of an aluminum alloy, and the tubular member 24 may be made of steel. Further, the member 28 of the clamshell assembly 22 may be cast, and the member 30 of the clamshell assembly 22 may be stamped or cast depending upon the profile or shape. The member 24, as a tubular member, may be stamped as two separate and elongated pieces that may be joined along two longitudinal seams 56 (see FIG. 3). In other embodiments, various components may be made of composite materials.

Referring to FIG. 5, a flow chart illustrates a method 100 of assembling the vehicle chassis structure 20. At block 102, the structural adhesive 26 may be placed on at least a portion of the convex face of the tubular member 24 that will generally oppose the concave surface 38 of the abutment portion 34. At block 104, the member 28 of the clamshell assembly 22 may be moved toward and pressed against the tubular member 24 in a joinder direction (see arrow 52 in FIG. 2) that is substantially normal to centerline C. Once pressed, the structural adhesive 26 is disposed radially between, and adhered to, the concave surface 38 and the convex face 50 with minimal adhesive wiping that would otherwise produce adhesive waste, add additional weight, and/or degrade adhesion performance.

At block 106, the structural adhesive 26 may be placed on the remaining, (i.e., exposed) portion of the convex face of the tubular member 24, or the concave surface 48 of the mid-segment 40. Further adhesive 26 may be placed on the tabs 42, 44, and, if the member 30 has the flange segment 46, on the flange segment 46. At block 108, the member 30 of the clamshell assembly 22 may be moved toward and pressed against the tubular member 24 in a joinder direction (see arrow 54 in FIG. 3) that includes a first vector or component that is substantially normal to centerline C (i.e., radial) and a second vector or component that is substantially normal to base surface 36 (i.e., axial) to reduce excessive adhesive wiping.

Once pressed, the structural adhesive 26 is disposed radially between, and adhered to, the concave surface 48 and the convex face 50, the flange segment 46 and the base surface 36, and the tabs 42, 44 and the concave surface 38. Both joinder directions 52, 54 may be termed diagonal directions. At block 110, heat may be applied to the chassis structure 20 to cure the structural adhesive 26. In one example, the heat may be applied as part of an e-coat process. It is contemplated and understood that joinder of the node 22 to tubular member 24 may be tunable and scalable for stiffness and strength. It is further understood that various fasteners may be secured at different locations between the members 24, 28, 30 to enhance strength, and improve fatigue and durability performance.

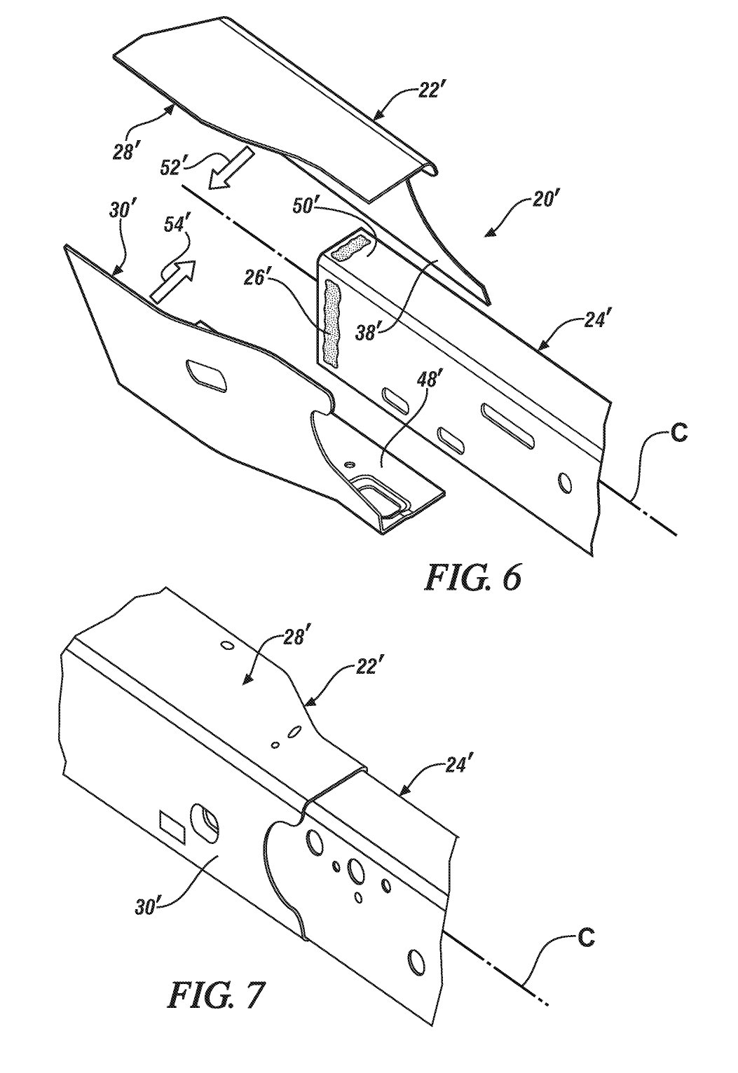

Referring to FIGS. 6 and 7, as second embodiment of a vehicle chassis structure is illustrated wherein like elements to the first embodiment have like identifying numerals with the addition of a prime symbol suffix. The clamshell assembly 22′ may include first and second members 28′, 30′ having respective concave surfaces 38′, 48′ facing radially inward with respect to centerline C. The tubular member 24′ may carry a circumferentially continuous convex face 50′. A structural adhesive 26′ may be placed on the convex face 50′ and the members 28′, 30′ may each be moved in respective joinder directions 52′, 54′ toward the tubular member 24′. The joiner directions 52′, 54′ may be opposite or opposing, radially inward, directions. In one example, two separate longitudinal halves of the tubular member 24′ may be stamped, then connected together to form the tubular member 24′. Alternatively, the tubular member 24′ may be manufactured using a roll form process. In the same example, the members 28′, 30′ of the clamshell assembly 22′ may be individually formed by a stamping process.

Advantages and benefits of the present disclosure include the ability to join dissimilar materials as part of a chassis structure, and utilizing a structural adhesive with reduced wiping during assembly.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle chassis structure comprising:
a clamshell assembly including a first member having a first concave surface and a second member having a second concave surface;
a third member having a convex face opposed to the first and second concave surfaces; and
a structural adhesive disposed between and in contact with the first concave surface and the convex face, and disposed between and in contact with the second concave surface and the convex face.

2. The vehicle chassis structure set forth in claim 1, wherein the convex face is circumferentially continuous.

3. The vehicle chassis structure set forth in claim 2, wherein the first and second concave surfaces extend circumferentially about the convex face.

4. The vehicle chassis structure set forth in claim 3, wherein the third member includes a center-point and the first and second concave surfaces are diametrically opposed to one-another with respect to the centerpoint.

5. The vehicle chassis structure set forth in claim 4, wherein the third member is an elongated member extending along a centerline that extends through the centerpoint.

6. The vehicle chassis structure set forth in claim 1, wherein the clamshell assembly and the third member are made of dissimilar materials.

7. The vehicle chassis structure set forth in claim 6, wherein the clamshell assembly is a node and the third member is one of a plurality of third members each attached to the node via the structural adhesive.

8. The vehicle chassis structure set forth in claim 7, wherein the vehicle chassis structure is an engine cradle.

9. The vehicle chassis structure set forth in claim 7, wherein the node is made of aluminum and the plurality of third members are made of steel.

10. The vehicle chassis structure set forth in claim 7, wherein the first member includes a base surface disposed substantially normal to the first concave surface, and the second member includes a flange segment adhered to the base surface via the structural adhesive.

11. The vehicle chassis structure set forth in claim 1, further comprising:
a fourth member including a fourth convex face, wherein the clamshell assembly includes a fifth member carrying a fifth concave surface, and wherein the first member includes a base portion, a first abutment portion projecting outward from the base portion and that carries the first concave surface, and a second abutment portion projecting outward from the base portion and carrying a fourth concave surface, and wherein the fourth and fifth concave surfaces are adhered to the fourth convex face via the structural adhesive.

12. A method of assembling a vehicle chassis structure comprising:
placing a structural adhesive upon at least one of a concave surface carried by the clamshell assembly and a convex face carried by the member; and
directing the clamshell assembly in a radially inward direction to compress the structural adhesive between the clamshell assembly and the convex face while minimizing adhesive wiping.

13. The method set forth in claim 12, wherein the clamshell assembly includes diametrically opposed first and second members each including respective first and second concave surfaces of the concave surface.

14. The method set forth in claim 13, wherein directing the clamshell assembly in a radially inward direction includes joining the first concave surface to the convex face and joining the second concave surface to the convex face.

15. The method set forth in claim 14, wherein the convex face is circumferentially continuous.

16. The method set forth in claim 15, wherein the first and second concave surfaces surround the convex face.

17. The method set forth in claim 12, further comprising applying heat to cure the structural adhesive.
